(19) United States
(12) Patent Application Publication
(10) Pub. No.: US 2002/0149607 A1
(43) Pub. Date: Oct. 17, 2002

(54) Gray-scale voltage producing method, gray-scale voltage producing circuit and liquid crystal display device

(75) Inventor: Masahiro Ito, Tokyo (JP)

Correspondence Address: HAYES SOLOWAY P.C., 175 CANAL STREET, MANCHESTER, NH, 03101-2335, US

(73) Assignee: NEC Corporation

(21) Appl. No.: 10/121,128

(22) Filed: Apr. 11, 2002

(30) Foreign Application Priority Data
Apr. 16, 2001 (JP) 117522/2001

(51) Int. Cl. G09G 5/10; G02B 23/00

(52) U.S. Cl. 345/690

(57) ABSTRACT

A method for producing a gray-scale voltage is provided which is capable of achieving a display of an image of high quality by using small-scale circuits and of reducing power consumption, and of providing satisfactory ease of use. In the above method, gray-scale voltages of positive or negative polarity are produced by converting a plurality of differential voltage value data each corresponding to a voltage difference between two gray-scale voltages existing in a manner adjacent to each other out of gray-scale voltages of positive or negative polarity into a plurality of analog voltages by using digital-analog converters and then by doing addition or subtraction of a reference voltage or two and more analog voltages using adders or subtracters.

### BACKGROUND OF THE INVENTION

1. Field of the Invention

The present invention relates to a method for producing a gray-scale voltage, a circuit for producing the gray-scale voltage, and a liquid crystal display device; and more particularly to the method for producing a plurality of the gray-scale voltages to display an image by providing a gray level of luminance to the liquid crystal display device, the gray-scale producing circuit using the above method and the liquid crystal display device equipped with such the gray-scale producing circuit.

The present application claims priority of Japanese Patent Application No. 2001-117522 filed on Apr. 16, 2001, which is hereby incorporated by reference.

2. Description of the Related Art

FIG. 7 is a schematic block diagram showing an example of configurations of a conventional liquid crystal display device disclosed in Japanese Patent Application Laid-open No. Hei 11-15442. The liquid crystal display device disclosed as above chiefly includes a liquid crystal display 1, a controller 2, a gray-scale voltage producing circuit 3, a data driver 4, and a scanning driver 5.

The liquid crystal display 1 is, for example, an active matrix-type color liquid crystal display using a thin film transistor (TFT) as a switching element. In the liquid crystal display 1, a region surrounded by a plurality of scanning electrodes (scanning lines) placed at specified intervals in a row direction and by a plurality of data electrodes (data lines) placed at specified intervals in a column direction, is used as a pixel. In each of the pixels in the color liquid crystal display 1, a pixel electrode being equivalently a capacitive load, a common electrode, and a TFT to drive the corresponding pixel electrode are arranged. To drive the color liquid crystal display 1, while a common voltage Vcom (not shown) is being applied to the common electrode, a data red signal, a data green signal, and a data blue signal respectively produced based on red data D_{R}, green data D_{G}, and blue data D_{B} each being digital video data are applied to a data line and a scanning signal produced based on a horizontal sync signal S_{H} vertical sync signal S_{V}, or a like are applied to a scanning line. This causes a color character or image to be displayed on a display screen of the color liquid crystal display 1.

The controller 2 converts the red data D_{R} with eight gray levels, green data D_{G} with eight gray levels, and blue data D_{B} with eight gray levels, all being fed from an external into display data D₀₀ to D₀₇, D₁₀ to D₁₇, and D₂₀ to D₂₇ respectively, in synchronization with a display clock CLK fed from an external and feeds the converted data to the data driver 4. Moreover, the controller 2 produces a scanning clock SCK and data clock DCK based on the above display clock CLK and the horizontal sync signal S_{H}, the vertical sync signal S_{V}, or a like each being supplied from an external and feeds the produced scanning clock SCK to the scanning driver 5 and the produced data clock DCK to the data driver 4.

The gray-scale voltage producing circuit 3 produces eight kinds of gray-scale voltages V₁ to V₈ and, based on gray-scale voltage setting data DG fed from an external, changes a voltage level of each of the gray-scale voltages V₁ to V₈. The gray-scale voltage setting data DG is made up of 1 bit of a start bit used to show a starting position of valid data, 3 bits of an address bit showing address information and 8 bits of data bit showing voltage value data. Address information is used to select any one of eight pieces of digital-analog converters (DACs) 12₁ to 12₈ which make up the gray-scale voltage producing circuit 3 to be described later. Moreover, the voltage value data is used to change a voltage level of each of the gray-scale voltages V₁ to V₈.

The data driver 4 selects one gray-scale voltage out of the gray-scale voltages V₁ to V₈ supplied from the gray-scale voltage producing circuit 3, based on one line of the display data D₀₀ to D₀₇, D₁₀ to D₁₇ and D₂₀ to D₂₇ captured in synchronization with the data clock DCK and applies the selected gray-scale voltage as a data red signal, data green signal, or data blue signal to a corresponding data line in the color liquid crystal display 1. The scanning driver 5 sequentially produces a scanning signal in synchronization with the scanning clock SCK and sequentially applies the produced signal to a corresponding scanning line in the color liquid crystal display 1.

Next, configurations of the gray-scale voltage producing circuit 3 will be explained by referring to FIG. 8.

The gray-scale voltage producing circuit 3 is made up of one chip of an LSI (Large Scale Integrated Circuit) including an interface circuit 11, digital-analog converters (DACs) 12₁ to 12₈, and buffer amplifiers 13₁ to 13₈. The interface circuit 11 has a DAC selected based on address information making up gray-scale voltage setting data DG supplied from an external latch voltage value data making up gray-scale voltage setting data DG. Each of the DACs 12₁ to 12₈ converts voltage value data being latched by each of the DACs 12₁ to 12₈ into an analog voltage and outputs the converted voltage. The analog voltage output from each of the DACs 12₁ to 12₈ is maintained at a same voltage level until new voltage value data is latched by the interface circuit 11. In the example, since each voltage value data is made up of 8 bits, each of the DACs 12₁ to 12₈ can output an analog voltage with a total of 256 levels. However, a maximum value of the analog voltage is set so as to become an allowable inputting level or below. Each of the buffer amplifiers 13₁ to 13₈ performs current amplification and impedance conversion on the analog voltage converted by each of corresponding DACs 12₁ to 12₈ and outputs the resulting voltage as the gray-scale voltages V₁ to V₈.

According to the configurations described as above, by executing an OS (Operation System) or application programs so that gray-scale voltage setting data DG is fed to the gray-scale voltage producing circuit 3 from an external, it is possible to make a gamma correction to a distortion in a gray-scale display characteristic caused by a characteristic being specific to the color liquid crystal display 1 and/or to obtain a gray-scale display characteristic which can suit preferences of a user or can match an image of an object to be displayed.

As described above, in the conventional gray-scale voltage producing circuit 3, each of the DACs 12₁ to 12₈ individually outputs an analog voltage with a total of 256 levels and each of the buffer amplifiers 13₁ to 13₈ performs current amplification and impedance conversion on an analog voltage converted by each of the corresponding DACs 12₁ to 12₈ and applies the resulting voltage to the data driver 4. Then, the data driver 4 selects one of the gray-scale voltages V₁ to V₈, based on one line of the captured display data D₀₀ to D₀₇, D₁₀ to D₁₇, and D₂₀ to D₂₇, and applies the selected voltage as data red signal, data green signal, or data blue signal to one of corresponding data lines in the color liquid crystal display 1. That is, in the conventional color liquid crystal display device, neither the gray-scale voltage producing circuit 3 nor the data driver 4 performs level-shifting or current amplification on the gray-scale voltage so that the gray-scale voltage is at a voltage level that can be applied to each of the data lines (for example, 8.5 V to 13 V, hereinafter, a level of a gray-scale voltage that can be applied is referred to as an “applicable voltage level”) in the color liquid crystal display 1. Thus, in order for the gray-scale voltage producing circuit 3 to produce a voltage being at the applicable voltage level, the DACs 12₁ to 12₈ each having a wide dynamic range and the buffer amplifiers 13₁ to 13₈ each also having a wide dynamic range are required. If the gray-scale voltage producing circuit 3 being equipped with such the DACs 12₁ to 12₈ each having such the wide dynamic range and the buffer amplifiers 13₁ to 13₈ each having such the wide dynamic range has to be configured by using one chip of the LSI, a scale of the circuit becomes extremely large and it is not practical and, even if it is practical, it costs much. Moreover, when level shifting or voltage amplification is performed on the gray-scale voltage so that the gray-scale voltage is at the applicable voltage level, since an error associated with the level shifting and voltage amplification occurs, the gray-scale voltage cannot be produced with high accuracy and a display of an image of high quality cannot be achieved. Furthermore, even if the gray-scale voltage producing circuit 3 is implemented using one chip of the LSI, since both the DACs 12₁ to 12₈ each having such the wide dynamic range and the buffer amplifiers 13₁ to 13₈ each having such the wide dynamic range consume much power, the color liquid crystal display device in the above example cannot be employed in a display device for portable electronic devices to be driven by a battery such as a notebook computer, palm-size computer and pocket computer, PDA (Personal Digital Assistant), portable cellular phone, PHS (Personal Handy-phone System), or a like.

Moreover, some of data drivers produce a plurality of gray-scale voltages by dividing gray-scale voltages fed from the gray-scale voltage producing circuit 3. Here, in order to distinguish the gray-scale voltage produced by the gray-scale voltage producing circuit 3 from the gray-scale voltage produced by the data driver 4, the latter is called an “applied gray-scale voltage”. When the plurality of the applied gray-scale voltages is produced, in normal cases, gray-scale voltages, for example, eight pieces of the gray-scale voltages V₁ to V₈ are applied to corresponding contact points of a ladder-type resistor in which a plurality of resistors is cascaded. Therefore, a relation among the gray-scale voltages V₁ to V₈ should be as shown in the following Expression (1).

GND<V₁<V₂<V₃<V₄<V₅<V₆<V₇<V₈<V_{DD} Expression (1)

Where V_{DD} denotes a supply voltage and GND denotes a ground voltage. Hereinafter, the Expression (1) is called an “input condition of the data driver”.

However, as described above, since each of the DACs 12₁ to 12₈ has to output an analog voltage being at the applicable voltage level, when the gray-scale voltage producing circuit 3 is practically used, it is necessary that the input condition of the data driver is satisfied and the gray-scale voltage setting data DG is set so that the gray-scale voltage is at the applicable voltage level. Therefore, the conventional gray-scale voltage producing circuit 3 provides unsatisfactory ease of use.

Also, in normal cases, a bit error of a DAC is about ±1 bit of a binary LSB (Least Significant Bit). On the other hand, as described above, each of the DACs 12₁ to 12₈ outputs an analog voltage being at the applicable voltage level. Therefore, the bit error of each of the DACs 12₁ to 12₈ becomes large, which makes it impossible to produce a gray-scale voltage with high accuracy and difficult to obtain an image of high quality.

Here, when it is presumed that a potential difference between a white level voltage which provides a highest gray level (hereinafter called a “maximum gray-scale voltage”) and a black level voltage which provides a lowest gray level (hereinafter called a “minimum gray-scale voltage”) is 4.5 V and that digital video data of 8 bits is to be displayed on the color liquid crystal display 1, the voltage V₁ for one gray level is given by the following Expression (2).

V₁=4.5[V]/256=17.6[mV] Expression (2)

Therefore, an output error ER of a DAC is given by the following Expression (3)

ER=17.6[mV]×2=35.2[mV] Expression (3)

On the other hand, in the liquid crystal display 1, generally, it a voltage applied to a data line changes by 20 [mV], the change in an image is made visible as an irregularity in a gray-scale voltage. Therefore, the output error ER of the DAC must be less than 20 [mV]. However, in the above conventional gray-scale voltage producing circuit 3, as shown in the Expression (3), the output error ER is 35.2 [mV] and therefore the irregularity in the gray-scale voltage is made visible. For example, in FIG. 9, when an image in which display luminance increases linearly from a left portion to a right portion (such the image is called a “gray-scale image”) is displayed in the color liquid crystal display 1, if the above conventional gray-scale voltage producing circuit 3 is used, though originally a gray level should become gradually higher from a left portion to a right portion, actually, the gray level on a right side becomes lower than that on a left side and vertical stripes are displayed on a display screen. Due to this shortcoming, the liquid crystal display device using the conventional gray-scale voltage producing circuit cannot be employed for use in a display device for medical electronic devices, in particular, in which a display of an image with high definition is required.

### SUMMARY OF THE INVENTION

In view of the above, it is an object of the present invention to provide a method for producing a gray-scale voltage and a circuit for producing the gray-scale voltage which enable a display of an image of high quality by using small-scale circuits and enable reduction of power consumption, and a liquid crystal display device using the above method and circuit which can provide satisfactory ease of use.

According to a first aspect of the present invention, there is provided a gray-scale voltage producing method for producing a plurality of gray-scale voltages to display an image by providing a gray level of luminance to a liquid crystal display device, the method including:

a step of producing, after having converted a plurality of digital data corresponding to a voltage difference between arbitrary two gray-scale voltages out of the plurality of the gray-scale voltages into analog voltages, the plurality of the gray-scale voltages by performing operational calculation on one analog voltage and a reference voltage or on at least arbitrary two analog voltages.

In the foregoing, a preferable mode is one that the reference voltage is a voltage which corresponds to a maximum value or a minimum value of each of the plurality of the gray-scale voltages.

Also, a preferable mode is one wherein the operational calculation is addition or subtraction.

Also, a preferable mode is one wherein the plurality of the gray-scale voltages is made up of a plurality of gray-scale voltages of positive polarity and a plurality of gray-scale voltages of negative polarity.

Also, a preferable mode is one wherein the plurality of the gray-scale voltages of positive polarity and the plurality of the gray-scale voltages of negative polarity are produced by operational calculation using a reference voltage of a same value.

According to a second aspect of the present invention, there is provided a gray-scale voltage producing circuit for producing a plurality of gray-scale voltages to display an image by providing a gray level of luminance to a liquid crystal display device, including:

a plurality of digital-analog converters to convert a plurality of digital data each corresponding to a voltage difference between two gray-scale voltages out of the plurality of the gray-scale voltages into analog voltages; and

a plurality of operational calculating units to perform operational calculation on one of the analog voltages and a reference voltage or on at least arbitrary two analog voltages.

In the foregoing, a preferable mode is one wherein the reference voltage is a voltage which corresponds to a maximum value or a minimum value of each of the plurality of the gray-scale voltages.

Also, a preferable mode is one wherein the operational calculating units are adders or subtracters.

Also, a preferable mode is one wherein the plurality of the gray-scale voltages is made up of a plurality of gray-scale voltages of positive polarity and a plurality of gray-scale voltages of negative polarity.

Also, a preferable mode is one wherein the plurality of the gray-scale voltages of positive polarity and the plurality of the gray-scale voltages of negative polarity are produced by operational calculation using a reference voltage of a same value.

Also, a preferable mode is one that wherein includes a storing device in which a plurality of digital data is stored in advance and a data supplying circuit to read the plurality of the digital data from the storing device when power is supplied and to feed the read digital data to each of the digital-analog converters.

According to a third aspect of the present invention, there is provided a liquid crystal display device provided with a gray-scale voltage producing circuit for producing a plurality of gray-scale voltages to display an image by providing a gray level of luminance to a liquid crystal display device, the gray-scale voltage producing circuit including:

a plurality of digital-analog converters to convert a plurality of digital data each corresponding to a voltage difference between two gray-scale voltages out of the plurality of the gray-scale voltages into analog voltages; and

a plurality of operational calculating units to perform operational calculation on one the analog voltage and a reference voltage or on at least arbitrary two the analog voltages.

With the above configurations, a display of an image of high quality can be achieved by using small-scale circuits, power consumption is reduced, and satisfactory ease of use can be provided.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of a gray-scale voltage producing circuit according to a first embodiment of the present invention;

FIG. 2 is a schematic block diagram showing configurations of a liquid crystal display device employing the gray-scale voltage producing circuit according to the first embodiment of the present invention;

FIG. 3 is a diagram showing one example of a relation between address bits and DACs according to the first embodiment of the present invention;

FIG. 4 is a schematic block diagram showing configurations of a gray-scale voltage producing circuit according to a second embodiment of the present invention;

FIG. 5 is a schematic block diagram showing configurations of a gray-scale voltage producing circuit according to a third embodiment of the present invention;

FIG. 6 is a diagram showing one example of a relation between a gray-scale voltage and luminance in a generalized liquid crystal display;

FIG. 7 is a schematic block diagram showing an example of configurations of a conventional liquid crystal display device disclosed in Japanese Patent Application Laid-open No. Hei 11-15442.

FIG. 8 is a schematic block diagram showing one example of configurations of a gray-scale voltage producing circuit making up the conventional liquid crystal display device; and

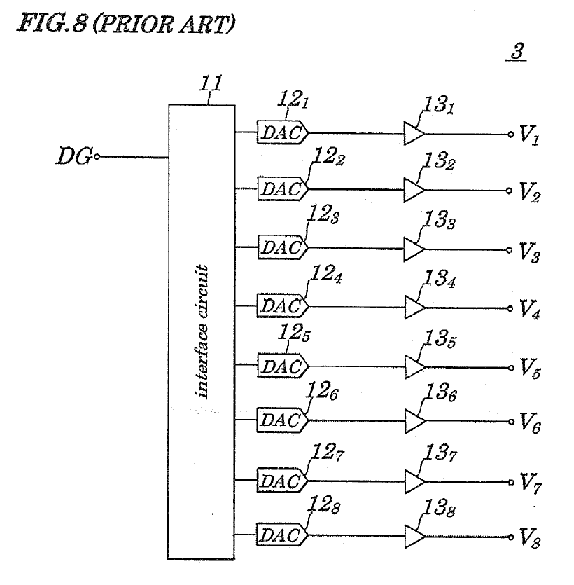

FIG. 9 is a diagram illustrating an example of display of a gray-scale image.

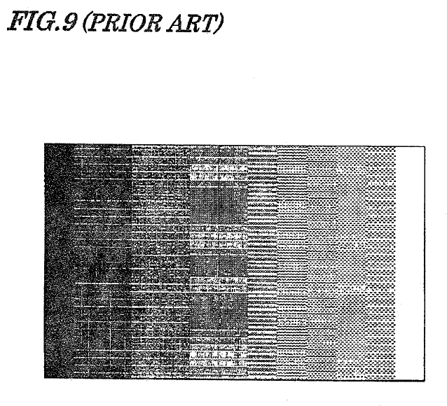

### DETAILED DESCRIPTION OF THE PREFERRED EMBODIMENTS

Best modes of carrying out the present invention will be described in further detail using various embodiments with reference to the accompanying drawings.

### First Embodiment

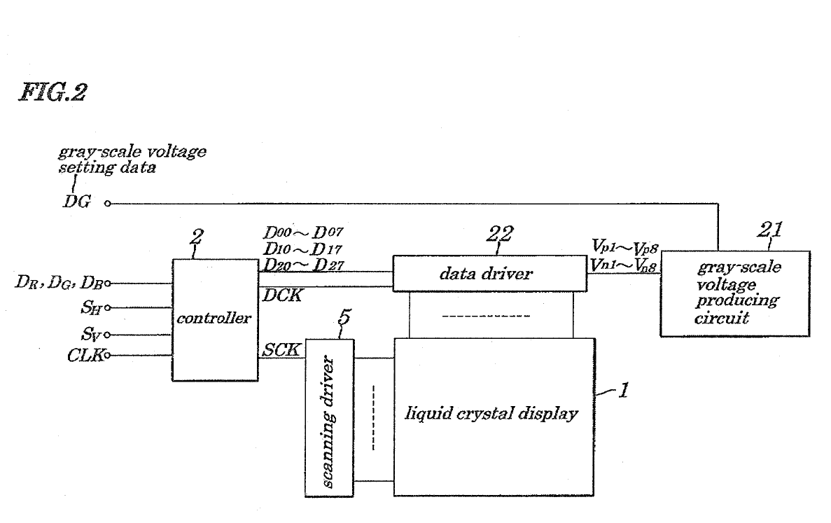

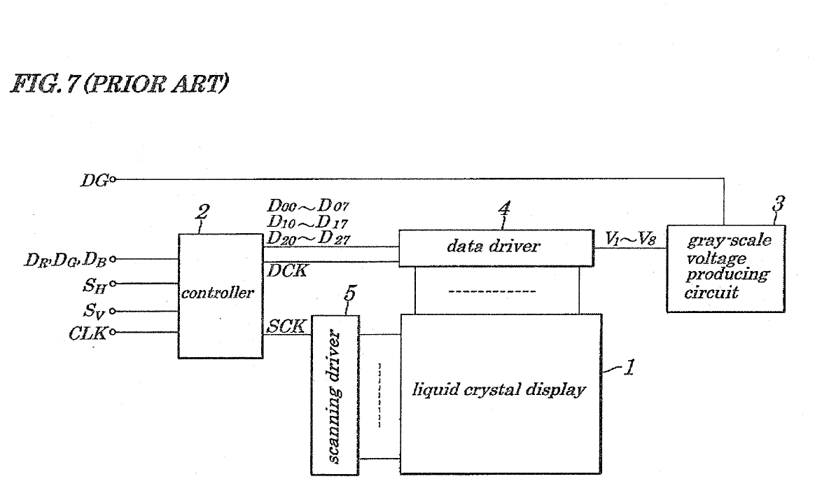

FIG. 2 is a schematic block diagram showing configurations of a liquid crystal display device employing a gray-scale voltage producing circuit 21 of a first embodiment of the present invention. In FIG. 2, same reference numbers are assigned to corresponding components having same functions as those shown in FIG. 7. In the liquid crystal display device shown in FIG. 2, instead of a gray-scale voltage producing circuit 3 and a data driver 4, the gray-scale voltage producing circuit 21 and a data driver 22 are newly provided.

The gray-scale voltage producing circuit 21 produces eight kinds of gray-scale voltages Vₚ₁ to Vₚ₈ of positive polarity and eight kinds of gray-scale voltages Vₙ₁ to Vₙ₈ of negative polarity and changes, based on gray-scale voltage setting data DG fed from an external, a voltage level of each of the gray-scale voltages Vₚ₁ to Vₚ₈ and of each of the gray-scale voltages Vₙ₁ to Vₙ₈. A relation among the gray-scale voltages Vₚ₁ to Vₚ₈ is as shown in the following Expression (4) and a relation among the gray-scale voltages Vₙ₁ to Vₙ₈ is as shown in the following Expression (5).

V_{REF}<Vₚ₁<Vₚ₂<Vₚ₃<Vₚ₄<Vₚ₅<Vₚ₆<Vₚ₇<Vₚ₈ Expression (4)

V_{REF}>Vₙ₁>Vₙ₂>Vₙ₃>Vₙ₄>Vₙ₅>Vₙ₆>Vₙ₇>Vₙ₈ Expression (5)

where V_{REF} denotes a reference voltage and is equal to, for example, a common potential V_{com}.

The reason why the gray-scale voltage producing circuit 21 of the embodiment is so configured as to produce the gray-scale voltages Vₚ₁ to Vₚ₈ and the gray-scale voltages Vₙ₁ to Vₙ₈ is as follows. That is, in a liquid crystal display, generally, when voltages being same in polarity are applied continuously to a liquid crystal cell, even if power is turned OFF, a phenomenon called “sticking” occurs in which a track of a character or a like is left on a display screen. To solve this problem, conventionally, as methods for driving a liquid crystal display, a method called a “dot reverse driving method”, a method called a “line reverse driving method”, and a method called a “frame reverse method” are employed. In the dot reverse driving method, a data signal which causes a polarity of a voltage that has to be applied to a pixel electrode to be reversed for every dot pixel relative to a common potential V_{com} being applied to a common electrode, is applied to a data line. Moreover, in the line reverse driving method, a data signal which causes a polarity of a voltage that has to be applied to a pixel electrode to be reversed for every line relative to a common potential V_{com} being applied to a common electrode, is applied to a data line and, at the same time, the common potential V_{com} is reversed, in response to application of the data signal, to a ground voltage level (GND) or to a supply voltage level. Furthermore, in the frame reverse driving method, a data signal which causes a polarity of a voltage that has to be applied to a pixel electrode to be reversed for every line relative to a common potential V_{com}, is applied to a data line and, at the same time, the common potential V_{com} is reversed, in response to application of the data signal, for every line and every frame. When these driving methods are employed, in a liquid crystal display, in ordinary cases, even if a polarity of a voltage to be applied to a liquid crystal cell is reversed, since the liquid crystal has almost a same transmittance characteristic, gray-scale voltages each having a same voltage both in a case of the gray-scale voltage being positive in polarity and in a case of the gray-scale voltage being negative in polarity are used. However, in some cases, the actual transmittance characteristic for a voltage applied to a liquid crystal cell is somewhat different between when a voltage of positive polarity is applied and when a voltage of negative polarity is applied, which is caused by a change of the voltage applied to a pixel electrode due to a switching noise of a TFT serving as a switching element or to parasitic capacitance of the TFT. Therefore, if the gray-scale voltages V₁ to V₈ each having a same voltage is used with only a polarity of the gray-scale voltages being reversed, a problem occurs that color correction becomes difficult and, as a result, it is impossible to obtain an image of high quality. To solve this problem, the gray-scale producing circuit 21 of the embodiment is so configured, by taking into consideration a case in which the characteristic of an applied voltage of a liquid crystal cell to transmittance differs between when a voltage of positive polarity is applied and when a voltage of negative polarity is applied, that it can produce the gray-scale voltages Vₚ₁ to Vₚ₈ of positive polarity and the gray-scale voltages Vₙ₁ to Vₙ₈ of negative polarity. This enables a display of an image of high quality.

The gray-scale voltage setting data DG is made up 1 bit of a start bit showing a starting position of valid data, 4 bits of address bits showing address information and 9 bits of data bits showing differential voltage value data. The address information is used to select any one of 16 pieces of DACs 32₁ to 32₈ and DACs 33₁ to 33₈ making up the gray-scale voltage producing circuit 21 described later. The differential voltage value data is used to change a differential voltage level to be output from each of the DACs 32₁ to 32₈ and 33₁ to 33₈ which corresponds to a voltage difference between two gray-scale voltages existing in a manner adjacent to each other.

The reason why the data bit, unlike in the conventional case where the data bit is voltage value data, is differential voltage data is as follows. That is, if the data bit is voltage value data and each of DACs 12₁ to 12₈ converts the voltage data into analog voltages, as in the conventional case, such the various inconveniences as described above occur that it is necessary that each of the DACs 12₁ to 12₈ and each of buffer amplifiers 13₁ to 13₈ have a wide dynamic range, that the liquid crystal display consumes much power, that the liquid crystal display provides unsatisfactory ease of use, and that there are great bit errors. To solve the problems, in the first embodiment, as the data bit, the differential voltage value data is used. Concrete effects to be obtained by using the differential voltage data as the data bit will be described later.

The data driver 22, by dividing the gray-scale voltages Vₚ₁ to Vₚ₈ of positive polarity and gray-scale voltages Vₙ₁ to Vₙ₈ of negative polarity both being supplied from the gray-scale voltage producing circuit 21, produces a plurality of applied gray-scale voltages of positive polarity and a plurality of applied gray-scale voltages of negative polarity. Then, the data driver 22 selects one applied gray-scale voltage out of a plurality of the applied gray-scale voltages of positive polarity or out of a plurality of the applied gray-scale voltages of negative polarity by using one line of display data D₀₀ to D₀₇, D₁₀ to D₁₇, and D₂₀ to D₂₇ captured in synchronization with a data clock DCK and feeds it as a data red signal, data green signal, or data blue signal to a corresponding data line in a liquid crystal display 1.

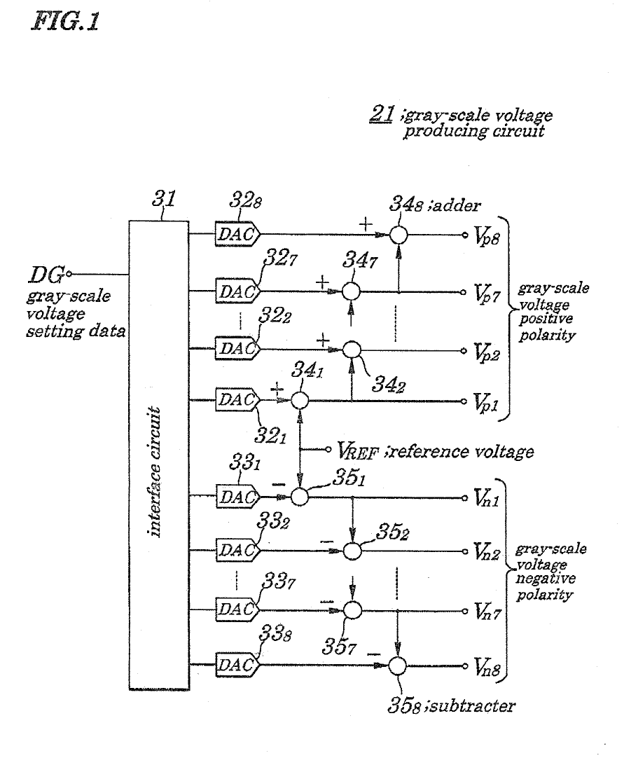

Next, configurations of the gray-scale voltage producing circuit 21 are described by referring to FIG. 1.

The gray-scale voltage producing circuit 21, as shown in FIG. 1, includes an interface circuit 31, DACs 32₁ to 32₈ and 33₁ to 33₈, adders 34₁ to 34₈, and subtracters 35₁ to 35₈. The interface circuit 31 has each of the DACs 32₁ to 32₈ and 33₁ to 33₈, selected by address information making up the gray-scale voltage setting data DG fed from an external latch differential voltage value data making up the gray-scale voltage setting data DG. Each of the DACs 32₁ to 32₈ and 33₁ to 33₈ converts the latched differential voltage value data into an analog voltage and outputs the converted voltage.

That is, in the embodiment, unlike in the case where each of the DACs 32₁ to 32₈ and 33₁ to 33₈ outputs an analog voltage corresponding to all gray-scale voltages with 256 gray levels, each of the DACs 32₁ to 32₈ and 33₁ to 33₈ outputs only an analog voltage corresponding to a voltage difference between two gray-scale voltages existing in a manner adjacent to each other out of the DACs 32₁ to 32₈ and 33₁ to 33₈. For example, the DAC 32₁, unlike in the case where the DAC converts a voltage for voltage value data into the gray-scale voltage Vₚ₁ itself, converts a voltage for the voltage value data into an analog voltage corresponding to a difference between a reference voltage V_{REF} and the gray-scale voltage Vₚ₁. Thereafter, each of the DAC 32₂ to 32₈ converts a voltage for differential voltage value data to be supplied into an analog voltage corresponding to a differential between two gray-scale voltages existing in a manner adjacent to each other out of the gray-scale voltages Vₚ₁ to V₈ of positive polarity. On the other hand, the DAC 33₁ converts a voltage for differential voltage value data into an analog voltage corresponding to a differential between the reference voltage V_{REF} and the gray-scale voltage Vₙ₁. Thereafter, each of the DACs 33₂ to 33₈ converts a voltage for differential voltage value data to be supplied into an analog voltage corresponding to a voltage difference between two gray-scale voltages existing in a manner adjacent to each other out of the gray-scale voltages Vₙ₁ to V₈ of negative polarity. The analog voltage output from each of the DACs 32₁ to 32₈ and 33₁ to 33₈ is maintained at a same voltage level until a voltage for new differential voltage value data is latched by the interface circuit 31. In the embodiment, 8 bits are assigned to the differential voltage value data and each of the DACs 32₁ to 32₈ and 33₁ to 33₈ can output an analog voltage with a total of 256 gray levels.

Each of the adders 34₁ to 34₈ adds a result obtained by adding the reference voltage V_{REF} or an addition result obtained from the adjacent one of the adders 34₁ to 34₇ to an analog voltage to be fed from each of the corresponding DACs 32₁ to 32₈ and outputs the resulting voltage as each of the gray-scale voltages Vₚ₁ to Vₚ₈ of positive polarity. Each of the subtracters 35₁ to 35₈ subtracts an analog voltage to be fed from each of corresponding DACs 33₁ to 33₈ from the reference voltage V_{REF} or from a subtraction result obtained from an adjacent subtracter of the subtracters 35₁ to 35₇ and outputs the resulting voltage as each of the gray-scale voltages Vₙ₁ to Vₙ₈ of negative polarity.

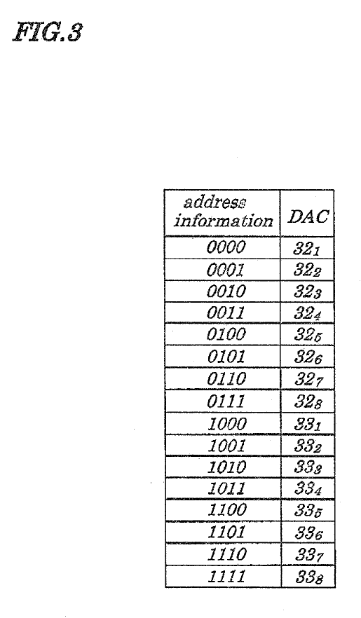

Next, operations of the gray-scale voltage producing circuit 21 having configurations as described above will be explained. First, when gray-scale voltage setting data is fed from an external, the interface circuit 31, based on the address information making up the gray-scale voltage setting data DG, selects any one of the DACs 32₁ to 32₈ and 33₁ to 33₈ and has any one of the DACs 32₁ to 32₈ and 33₁ to 33₈ latch differential voltage value data making up the gray-scale voltage setting data DG. Here, one example of a relation between the address information and each of the DACs 32₁ to 32₈ and 33₁ to 33₈ is shown in FIG. 3. For example, if the address information is “0000”, the interface circuit 31 selects the DAC 32₁ and has the DAC 32₁ latch differential voltage value data following the address information, for example, “00000010”. Similarly, the interface circuit 31, based on the address information making up the gray-scale voltage setting data DG to be sequentially fed from an external, has each of the DACs 32₁ to 32₈ and 33₁ to 33₈ latch differential voltage value data making Up the gray-scale voltage setting data DG.

Each of the DACs 32₁ to 32₈ and DACs 33₁ to 33₈ converts a voltage for the differential voltage value data being latched into an analog voltage and outputs it. The analog voltage output from each of the DACs 32₁ to 32₈ and DACs 33₁ to 33₈ is maintained at a same voltage level until a voltage for new voltage value data is latched by the interface circuit 31. Next, the adder 34₁ adds the analog voltage fed from the DAC 32₁ to the reference voltage V_{REF} and outputs a voltage obtained from the addition as the gray-scale voltage Vₚ₁ of positive polarity. Moreover, the adder 34₂ adds an addition result obtained from the adders 34₁ to the analog voltage fed from the DAC 32₂ and outputs a voltage obtained from the addition as the gray-scale voltage Vₚ₂ of positive polarity. Similarly, each of the adders 34₃ to 34₈ adds an addition result obtained from an adjacent one of the adders 34₂ to 34₇ to an analog voltage fed from each of corresponding DACs 32₃ to 32₈ and outputs a voltage obtained from the addition as each of the gray-scale voltages Vₚ₃ to Vₚ₈ of positive polarity. On the other hand, the subtracter 35₁ subtracts the analog voltage fed from the DAC 33₁ from the reference voltage V_{REF} and outputs a voltage obtained from the subtraction as the gray-scale voltage Vₙ₁ of negative polarity. Also, the subtracter 35₂ subtracts the analog voltage fed from the DAC 33₂ from a subtraction result obtained from the subtracter 35₁ and outputs a voltage obtained from the subtraction as the gray-scale voltage Vₙ₂ of negative polarity. Similarly, each of the subtracters 35₃ to 35₈ subtracts the analog voltage fed from each of corresponding DACs 33₃ to 33₈ from a subtraction result obtained from an adjacent one of the subtracters 35₂ to 35₇ and outputs a voltage obtained from the subtraction as each of the gray-scale voltages Vₙ₃ to Vₙ₈ of negative polarity.

The gray-scale voltages Vₚ₁ to Vₚ₈ of positive polarity and the gray-scale voltages Vₙ₁ to Vₙ₈ of negative polarity are fed to the data driver 22. The data driver 22 divides the gray-scale voltages Vₚ₁ to Vₚ₈ of positive polarity and the gray-scale voltages Vₙ₁ to Vₙ₈ of negative polarity and produces a plurality of applied gray-scale voltages of positive polarity and a plurality of applied gray-scale voltages of negative polarity. Then, the data driver 22 selects one applied gray-scale voltage by using one line of display data D₀₀ to D₀₇, D₁₀ to D₁₇, and D₂₀ to D₂₇ captured in synchronization with the data clock DCK, out of the plurality of applied gray-scale voltages of positive polarity and the plurality of applied gray-scale voltages of negative polarity and applies it to as a data red signal, data green signal, or data blue signal to corresponding data line in the liquid crystal display 1.

Thus, according to the first embodiment, in each of the adders 34₁ to 34₈, the reference voltage V_{REF} or an addition result obtained from an adjacent one of the adders 34₁ to 34₇ is added to the analog voltage converted from the voltage for the differential voltage value data by each of corresponding DACs 32₁ to 32₈ and the resulting voltage value is output as each of the gray-scale voltages Vₚ₁ to Vₚ₈ of positive polarity. Moreover, in the subtracters 35₁ to 35₈, the analog voltage converted from the voltage for the differential voltage value data by each of the corresponding DACs 33₁ to 33₈ is subtracted from the reference voltage V_{REF} or from a subtraction result obtained from an adjacent one of the subtracters 35₁ to 35₇ and the resulting voltage is output as each of the gray-scale voltages Vₙ₁ to Vₙ₈ of negative polarity.

Therefore, as in the case of the conventional technology, it is possible to make a gamma correction to a distortion in a gray-scale display characteristic caused by a characteristic being specific to the liquid crystal display 1 and/or to obtain a gray-scale display characteristic which can suit preferences of a user or can match an image of an object to be displayed. Additionally, by setting the reference voltage V_{REF} at an appropriate value, it is possible to easily produce gray-scale voltages Vₚ₁ to Vₚ₈ and Vₙ₁ to Vₙ₈ at an applicable voltage level. As a result, the dynamic range of each of the DACs 32₁ to 32₈ and DACs 33₁ to 33₈ can be made narrow compared with the conventional case. This enables the gray-scale voltage producing circuit 21 to be configured so as to have low-priced LSIs having DACs with the narrow dynamic range. Moreover, since the dynamic range of each of the DACs 32₁ to 32₈ and DACs 33₁ to 33₈ is made narrow, power consumption can be reduced more compared with the conventional case. As a result, the liquid crystal display 1 of the first embodiment can be used as a display device for portable electronic devices that are driven by a battery or a like.

Also, according to the first embodiment, since level shifting or voltage amplification to make the gray-scale voltage and applied gray-scale voltage be at an applicable voltage level is not required, it is possible to produce a gray-scale voltage with high accuracy and to achieve a display of an image of high quality.

Also, according to the first embodiment, a device which feeds gray-scale voltage setting data DG, for example, an information processing device such as a personal computer, or a like may feed the differential voltage value data as a data bit. As a result, it is not necessary for the information processing device to check whether or not the differential voltage value data making up the gray-scale voltage setting data DG sequentially being fed satisfies inputting conditions of the above data driver and to check whether or not the voltage is at the applicable voltage level, which can provide ease of use. Moreover, since the voltage for the differential voltage value data is converted into an analog voltage by the DACs 32₁ to 32₈ and DACs 33₁ to 33₈, a potential difference between an upper limit and lower limit of each of output voltages of the DACs 32₁ to 32₈ and DACs 33₁ to 33₈ can be set to be small. This enables errors in the DACs 32₁ to 32₈ and DACs 33₁ to 33₈ to be reduced. For example, when the number of bits of a digital video data fed from an external is 8 bits and a potential difference between the upper limit and lower limit of each of the output voltage of the DACs 32₁ to 32₈ and DACs 33₁ to 33₈ is 2.0 [V] and the bit error of a DAC is about ±1 bit of a binary LSB, an output error ER is smaller than 20 [mV] as shown in the Expression (6), the irregularity of the gray-scale is made invisible. For example, even in the case of display of a gray scale image, vertical stripes are not visible. This can achieve a display of an image of high quality.

ER=2.0[V]/256×2≈15.6[mV] Expression (6)

### Second Embodiment

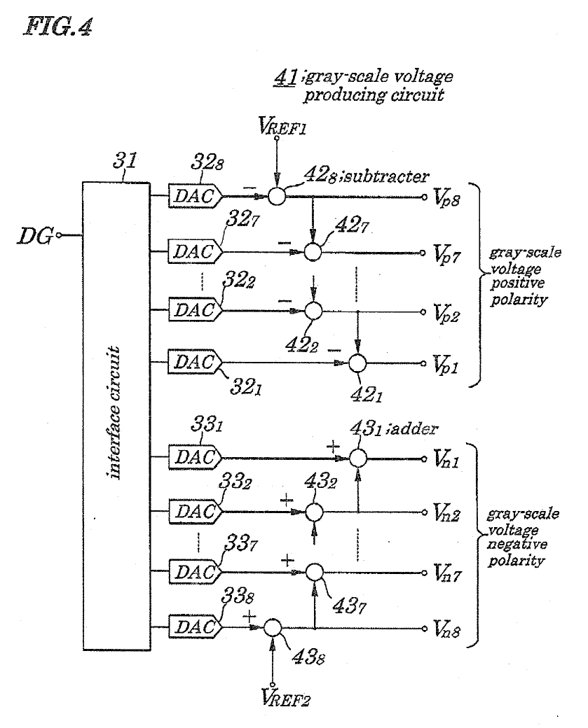

FIG. 4 is a schematic block diagram showing configurations of a gray-scale voltage producing circuit 41 of a second embodiment of the present invention. In FIG. 4, same reference numbers are assigned to corresponding components having the same functions as those in the first embodiment shown in FIG. 1 and their descriptions are omitted accordingly. In the gray-scale voltage producing circuit 41 shown in FIG. 4, instead of adders 34₁ to 34₈ and subtracters 35₁ to 35₈ subtracters 42₁ to 42₈ and adders 43₁ to 43₈ are newly provided.

A DAC 32₈ converts a voltage for differential voltage value data to be supplied into an analog voltage corresponding to a differential between a gray-scale voltage Vₚ₈ and a first reference voltage V_{REF1}. Thereafter, each of DACs 32₇ to 32₁ converts a voltage for differential voltage value data to be supplied into an analog voltage corresponding to a differential between two gray-scale voltages existing in a manner adjacent to each other out of the gray-scale voltages Vₚ₈ to Vₚ₂ of positive polarity. On the other hand, a DAC 33₈ converts a voltage for differential voltage value data to be supplied into an analog voltage corresponding to a differential between a gray-scale voltage Vₙ₁ and a second reference voltage V_{REF2}. Thereafter, each of the DACs 33₇ to 33₁ converts a voltage for differential voltage value data to be supplied into an analog voltage corresponding to a differential between two gray-scale voltages existing in a manner adjacent to each other out of the gray-scale voltages Vₙ₈ to Vₙ₂ of negative polarity. The analog voltage output from each of the DACs 32₁ to 32₈ and 33₁ to 33₈ is maintained at a same voltage level until a voltage for new differential voltage value data is latched by an interface circuit 31.

Each of the subtracters 42₈ to 42₁ subtracts an analog voltage fed from each of corresponding DACs 32₈ to 32₁ from the first reference voltage V_{REF1} or from a subtraction value obtained from an adjacent one of the subtracters 42₈ to 42₂ and outputs the resulting voltage value as each of the gray-scale voltages Vₚ₈ to Vₚ₁ of positive polarity. Each of the adders 43₈ to 43₁ adds the second reference voltage V_{REF2} or an addition result obtained from an adjacent one of the adders 43₈ to 43₂ to an analog voltage fed from each of corresponding DACs 33₈ to 33₁ and outputs the resulting voltage value as each of the gray-scale voltages Vₙ₈ to Vₙ₁ of negative polarity.

Moreover, operations of the gray voltage producing circuit 41 having the above configurations are the same as those in the first embodiment except for three points described below and their descriptions are omitted accordingly. That is, the operations of the gray-scale voltage producing circuit 41 differ from those in the first embodiment in that a voltage for differential voltage value data is different in each of the DACs 32₁ to 32₈ and 33₁ to 33₈, that the gray-scale voltages Vₚ₁ to Vₚ₈ of positive polarity are obtained by subtraction and that the gray-scale voltages Vₙ₁ to Vₙ₈ of negative polarity are obtained by addition.

Thus, according to the second embodiment, same effects obtained in the first embodiment can be also achieved.

### Third Embodiment

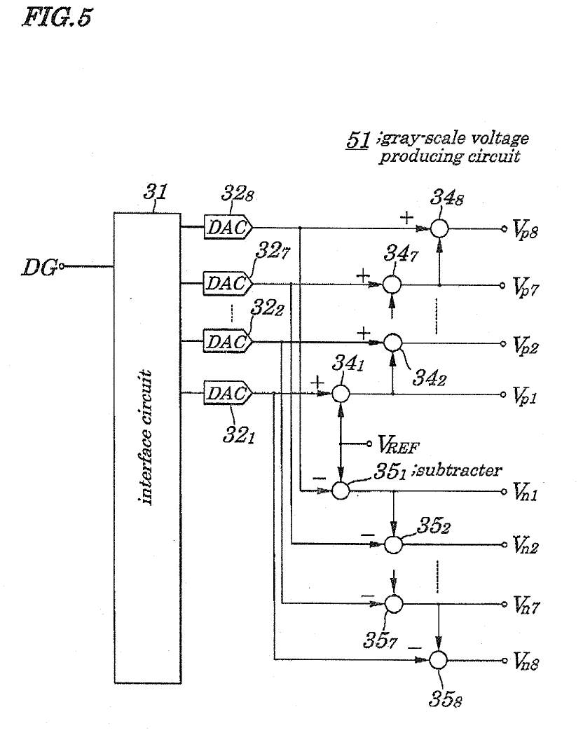

FIG. 5 is a schematic block diagram showing configurations of a gray-scale voltage producing circuit 51 according to a third embodiment of the present invention. In FIG. 5, same reference numbers are assigned to corresponding components having the same functions as in the first embodiment shown in FIG. 1 and their descriptions are omitted accordingly. In the gray-scale voltage producing circuit 51 shown in FIG. 5, DACs 33₁ to 33₈ shown in FIG. 1 are removed and an output terminal of each of the DACs 32₁ to 32₈ is connected to an input terminal of each of subtracters 35₁ to 35₈.

Each of the DACs 32₁ to 32₈ converts a voltage for differential voltage value data latched by an interface circuit 31 and outputs it. Each of adders 34₁ to 34₈ adds a reference voltage V_{REF} an addition result obtained from an adjacent one of the adders 34₁ to 34₇ to an analog voltage fed from each of corresponding DACs 32₁ to 32₈ and outputs the resulting voltage as each of gray-scale voltages Vₚ₁ to Vₚ₈ of positive polarity. The analog voltage output from each of the DACs 32₁ to 32₈ is maintained at a same voltage level until a voltage for new differential voltage value data is latched by the interface circuit 31. Each of the subtracters 35₁ to 35₈ subtracts an analog voltage fed from each of corresponding DACs 32₁ to 32₈ from the reference voltage V_{REF} or a subtraction result from an adjacent one of the subtracters 35₁ to 35₇ and outputs the resulting voltage as each of gray-scale voltages Vₙ₁ to Vₙ₈ of negative polarity. In this case, address information may be made up of only 3 bits, that is, 8 pieces in high order in a relation diagram between address information and DAC shown in FIG. 3.

Moreover, operations of the gray-scale voltage producing circuit 51 having configurations described above are the same as those in the first embodiment except for two points shown below and their descriptions are omitted accordingly. That is, the operations of the gray-scale voltage producing circuit 51 differ from those in the first embodiment in that a voltage for differential voltage value data to be fed to each of the DACs 32₁ to 32₈ is different and that the gray-scale voltages Vₙ₁ to Vₙ₈ of negative polarity are obtained by an analog voltage fed from each of the DACs 32₁ to 32₈.

Thus, according to the third embodiment, same effects obtained in the first embodiment can be achieved. Additionally, a scale of the circuit can be reduced more compared with the cases of the first and second embodiments.

Moreover, in the above first and second embodiments, the gray-scale voltages Vₚ₁ to Vₚ₈ of positive polarity and the gray-scale voltages Vₙ₁ to Vₙ₈ of negative polarity are produced in order to correspond to a fact that an applied voltage to transmittance characteristic of a liquid crystal cell is different between in the case of applied voltage of positive polarity and in the case of applied voltage of negative polarity. This enables a display of an image of high quality. However, when the liquid crystal display is used in applications that requires no high-quality image or when the liquid crystal display in which the difference in the applied voltage to transmittance characteristic of a liquid crystal cell between in the case of applied voltage of positive polarity and in the case of applied voltage of negative polarity is negligible is driven, no problem occurs practically even if the gray-scale voltages Vₚ₁ to Vₚ₈ of positive polarity and the gray-scale voltages Vₙ₁ to Vₙ₈ of negative polarity are produced from a voltage value for same differential voltage value data as in the case of the third embodiment. Moreover, when a dot reverse driving method, line reverse driving method or frame reverse driving method is employed, in ordinary cases, since a polarity of a gray-scale voltage is reversed, in either of a gray-scale voltage producing circuit 3 or a data driver 4, switching is required so that one of gray-scale voltage V₁ and gray-scale voltage V₈ is used as a maximum gray-scale voltage and another is used as a minimum gray-scale voltage. In the third embodiment, the gray-scale voltages Vₚ₁ to Vₚ₈ of positive polarity and the gray-scale voltages Vₙ₁ to Vₙ₈ of negative polarity are produced separately, therefore such the switching is not required.

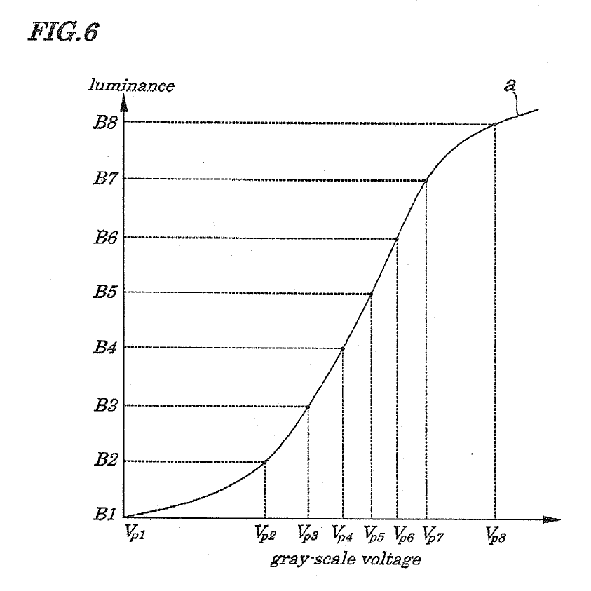

It is apparent that the present invention is not limited to the above embodiments but may be changed and modified without departing from the scope and spirit of the invention. For example, in each of the above embodiments, it is presumed that the dynamic range of each DAC is equal, however, the dynamic range of each DAC may be different. The reason why the dynamic range of each DAC may be different is that a relation between a gray-scale voltage and luminance in a liquid crystal display is nonlinear as shown in FIG. 6 and values of gray-scale voltages are not set at equal intervals. Specifically, the dynamic range of a DAC used to convert a voltage for differential voltage value data corresponding to a maximum gray-scale voltage, minimum gray-scale voltage, and a gray-scale voltage being near the maximum or minimum gray-scale voltages into an analog voltage may be set to be wider and the dynamic range of a DAC used to convert a voltage for differential voltage value data corresponding to a gray-scale voltage at a center voltage level may be set to be narrow.

Moreover, in each of the above embodiments, the example is shown in which there is a one-to-one correspondence between the number of gray-scale voltages to be produced and the number of differential voltage value data, however, the present invention is not limited to this. For example, the number of the differential voltage value data may be set to be smaller than that of the gray-scale voltages to be produced and desired number of the gray-scale voltages may be produced by calculating the differential voltage value data by using the adder or subtracter. Moreover, the differential voltage value data is not limited to the gray-scale voltages existing in a manner being adjacent to each other.

Also, in each of the above embodiments, the example is shown in which the gray-scale voltage setting data is supplied from an external, however, the present invention is not limited to this. That is, for example, the gray-scale voltage producing circuit may be so configured that the gray-scale voltage setting data is stored in advance in a storing device such as a register, latch, memory, or a like mounted in an inside or an external of the interface circuit and, after power is supplied to the liquid crystal display, the gray-scale voltage setting data is read from the above storing device and is latched by each of the DACs.

Also, in the above first and third embodiments, the gray-scale voltages Vₚ₁ to Vₚ₈ of positive polarity and the gray-scale voltages Vₙ₁ to Vₙ₈ of negative polarity are produced by using the same reference voltage V_{REF}, however, they may be produced by using a different voltage.

Also, in each of the above embodiments, the example is shown in which the number of the gray-scale voltages of the same polarity is eight, however, it may be larger or smaller than eight pieces.

Also, in each of the above embodiments, the gray-scale voltage of the same polarity is produced by using the arithmetic operational units of the same kind, however, it can be produced by using different arithmetic operational units, that is, the adders or subtracters.

Also, in each of the embodiments, the reference voltage is set to be on a side of the minimum gray-scale voltage or the maximum gray-scale voltage, however, it can be set at a gray-scale voltage at a center voltage level, for example, at a voltage being near the gray-scale voltages Vₚ₃, Vₚ₄, Vₙ₃, and Vₙ₄.

Moreover, in each of the above embodiments, each of the gray-scale voltage producing circuit and the data driver is provided individually and separately, however, the gray-scale voltage producing circuit may be mounted within the data driver.

Furthermore, the present invention may be applied to not only a color liquid display but also a monochrome liquid crystal display.

What is claimed is:

1. A gray-scale voltage producing method for producing a plurality of gray-scale voltages to display an image by providing a gray level of luminance to a liquid crystal display device, said method comprising:
a step of producing, after having converted a plurality of digital data corresponding to a voltage difference between arbitrary two gray-scale voltages out of said plurality of said gray-scale voltages into analog voltages, said plurality of said gray-scale voltages by performing operational calculation on one said analog voltage and a reference voltage or on at least arbitrary two said analog voltages.

2. The gray-scale voltage producing method according to claim 1, wherein said reference voltage is a voltage which corresponds to a maximum value or a minimum value of each of said plurality of said gray-scale voltages.

3. The gray-scale voltage producing method according to claim 1, wherein said operational calculation is addition or subtraction.

4. The gray-scale voltage producing method according to claim 1, wherein said plurality of said gray-scale voltages is made up of a plurality of gray-scale voltages of positive polarity and a plurality of gray-scale voltages of negative polarity.

5. The gray-scale voltage producing method according to claim 4, wherein said plurality of said gray-scale voltages of positive polarity and said plurality of said gray-scale voltages of negative polarity are produced by operational calculation using a reference voltage of a same value.

6. A gray-scale voltage producing circuit for producing a plurality of gray-scale voltages to display an image by providing a gray level of luminance to a liquid crystal display device, comprising:
a plurality of digital-analog converters to convert a plurality of digital data each corresponding to a voltage difference between two gray-scale voltages out of said plurality of said gray-scale voltages into analog voltages; and
a plurality of operational calculating units to perform operational calculation on one said analog voltage and a reference voltage or on at least arbitrary two said analog voltages.

7. The gray-scale voltage producing circuit according to claim 6, wherein said reference voltage is a voltage which corresponds to a maximum value or a minimum value of each of said plurality of said gray-scale voltages.

8. The gray-scale voltage producing circuit according to claim 6, wherein said operational calculating units are adders or subtracters.

9. The gray-scale voltage producing circuit according to claim 6, wherein said plurality of said gray-scale voltages is made up of a plurality of gray-scale voltages of positive polarity and a plurality of gray-scale voltages of negative polarity.

10. The gray-scale voltage producing circuit according to claim 9, wherein said plurality of said gray-scale voltages of positive polarity and said plurality of said gray-scale voltages of negative polarity are produced by operational calculation using a reference voltage of a same value.

11. The gray-scale voltage producing circuit according to claim 6, further comprising a storing device in which said plurality of said digital data is stored in advance and a data supplying circuit to read said plurality of said digital data from said storing device when power is supplied and to feed said read digital data to each of said digital-analog converters.

12. A liquid crystal display device provided with a gray-scale voltage producing circuit for producing a plurality of gray-scale voltages to display an image by providing a gray level of luminance to a liquid crystal display device, said gray-scale voltage producing circuit comprising:
a plurality of digital-analog converters to convert a plurality of digital data each corresponding to a voltage difference between two gray-scale voltages out of said plurality of said gray-scale voltages into analog voltages; and
a plurality of operational calculating units to perform operational calculation on one said analog voltage and a reference voltage or on at least arbitrary two said analog voltages.

13. The liquid crystal display device according to claim 12, wherein said reference voltage is a voltage which corresponds to a maximum value or a minimum value of each of said plurality of said gray-scale voltages.

14. The liquid crystal display device according to claim 12, wherein said operational calculating units are adders or subtracters.

15. The liquid crystal display device according to claim 12, wherein said plurality of said gray-scale voltages is made up of a plurality of gray-scale voltages of positive polarity and a plurality of gray-scale voltages of negative polarity.

16. The liquid crystal display device according to claim 15, wherein said plurality of said gray-scale voltages of positive polarity and said plurality of said gray-scale voltages of negative polarity are produced by operational calculation using a reference voltage of a same value.

17. The liquid crystal display device according to claim 12, further comprising a storing device in which said plurality of said digital data is stored in advance and a data supplying circuit to read said plurality of said digital data from said storing device when power is supplied and to feed said read digital data to each of said digital-analog converters.
